(19) United States
(12) Patent Application Publication
(10) Pub. No.: US 2026/0257720 A1
(43) Pub. Date: Sep. 3, 2026

(54) Steering Control Apparatus, Steering Control Method, and Steer-By-Wire System

(71) Applicant: Hitachi Astemo, Ltd., Hitachinaka-shi, Ibaraki (JP)

(72) Inventor: Huajun LIU, Hitachinaka-shi, Ibaraki (JP)

(21) Appl. No.: 18/993,331

(22) PCT Filed: Aug. 21, 2023
(86) PCT No.: PCT/JP2023/029917

§ 371 Date: Jan. 10, 2025

(30) Foreign Application Priority Data
Sep. 8, 2022 (JP) 2022-142819

(51) Int. Cl. B62D 5/04; B62D 6/00; B62D 6/02

(52) U.S. Cl. CPC B62D 5/046; B62D 6/002; B62D 6/02

(57) ABSTRACT

The present invention provides a steering control apparatus, a steering control method, and a steer-by-wire system. In one aspect, the steer-by-wire system includes a first actuator that applies torque to a steering operation input member, and includes a second actuator that applies steering force to road wheels. When the system is turned ON, if the deviation amount of the steering angle of the road wheels with respect to the operation position of the steering operation input member is equal to or greater than a tolerable amount, and if the vehicle speed is equal to or less than a threshold, the first actuator is controlled such that the deviation amount is reduced. If the vehicle speed is greater than the threshold, the second actuator is controlled such that the deviation amount is reduced. In this way, it is possible to prevent a control for aligning the operation position and the steering angle from negatively affecting vehicle maintenance or vehicle driving.

### TECHNICAL FIELD

The present invention relates to a steering control apparatus, a steering control method, and a steer-by-wire system.

### BACKGROUND ART

Patent Document 1 discloses a steering apparatus including a motor that applies simulated steering reaction force to a steering wheel.

With this steering apparatus, when an ignition switch is OFF, and when a deviation is generated between the steering angle of the steered road wheels and the rotational position of the steering wheel, an ECU drives the motor, and the motor's driving force in a direction which is opposite to the rotation direction of the steering wheel is applied to the steering wheel.

As a result, the steering wheel rotates such that its rotation position matches the steering angle of the steered road wheels.

### REFERENCE DOCUMENT LIST

### Patent Document

Patent Document 1: JP 2006-321434 A

### SUMMARY OF THE INVENTION

### Problem to be Solved by the Invention

In the case of a vehicle equipped with a steer-by-wire system, the steering angle of the road wheels may deviate from the operation position of a steering operation input member such as the steering wheel. As the alignment controls for reducing this deviation, there are a control that moves the operation position of the steering operation input member to a position matching the steering angle of the road wheels, and a control that moves the steering angle of the road wheels to an angle matching the operation position of the steering operation input member.

However, whether one of the alignment controls needs to be executed when the steer-by-wire system is ON needs to be determined by using the condition of the vehicle speed.

Otherwise, maintenance work on the vehicle may be hindered, or vehicle behavior not intended by the driver of the vehicle may occur.

The present invention has been made in view of these conventional circumstances, and an object of the present invention is to provide a steering control apparatus, a steering control method, and a steer-by-wire system that can prevent a control for aligning the operation position of a steering operation input member and the steering angle of a road wheel from negatively affecting vehicle maintenance or vehicle driving.

### Means for Solving the Problem

In one aspect of an invention according to the present invention, a steer-by-wire system includes a first actuator that applies torque to a steering operation input member, and includes a second actuator that applies steering force to road wheels of a vehicle. When the system is turned ON, if the deviation amount of the steering angle of the road wheels with respect to the operation position of the steering operation input member is equal to or greater than a tolerable amount, and if the vehicle speed is equal to or less than a threshold, a control signal is output to the first actuator such that the deviation amount is reduced. If the vehicle speed is greater than the threshold, a control signal is output to the second actuator such that the deviation amount is reduced.

### Effects of the Invention

The present invention can prevent a control for aligning the operation position of a steering operation input member and the steering angle of a road wheel from negatively affecting vehicle maintenance or vehicle driving.

### BRIEF DESCRIPTION OF THE DRAWINGS

FIG. 1 schematically illustrates a vehicle in which a steer-by-wire system is mounted.

FIG. 2 illustrates the alignment control state transition.

FIG. 3 illustrates the transition of the control state of a reaction force motor and the transition of the control state of a steering motor.

FIG. 4 is a flowchart illustrating the control flow of the steer-by-wire system.

FIG. 5 illustrates an example of how the alignment based on a first alignment control is executed.

FIG. 6 illustrates another example of how the alignment based on the first alignment control is executed.

FIG. 7 illustrates an example of how the alignment based on a second alignment control is executed.

FIG. 8 illustrates another example of how the alignment based on the second alignment control is executed.

FIG. 9 illustrates an example of how the alignment based on the second alignment control is executed when the vehicle starts moving.

FIG. 10 illustrates an example of how the alignment is executed manually.

FIG. 11 is a flowchart illustrating the process contents in an alignment mode.

FIG. 12 is a graph illustrating the correlation between the speed limit and the vehicle speed in the second alignment control.

FIG. 13 is a flowchart illustrating the process contents in an alignment mode in which whether the vehicle is in a stopped state or a running state is determined based on an accelerator operation amount.

FIG. 14 illustrates a steer-by-wire system in which a steering operation input apparatus includes a steering control apparatus.

FIG. 15 illustrates a steer-by-wire system in which a steering apparatus includes a steering control apparatus.

### MODE FOR CARRYING OUT THE INVENTION

Hereinafter, examples of a steering control apparatus, a steering control method, and a steer-by-wire system according to the present invention will be described with reference to the drawings.

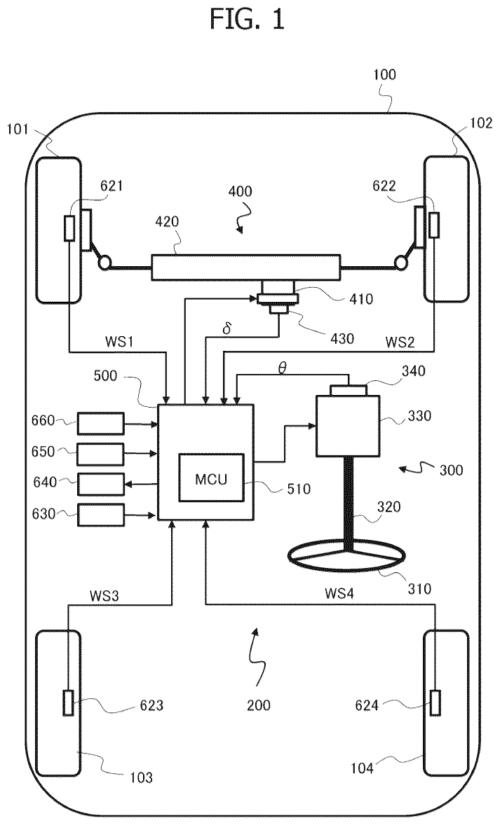

FIG. 1 is a schematic diagram illustrating a mode of a vehicle 100 in which a steer-by-wire system 200 is mounted.

Vehicle 100 is a four-wheel vehicle having a pair of right and left front road wheels 102 and 101 and a pair of right and left rear road wheels 104 and 103.

Steer-by-wire system 200 includes a steering operation input apparatus 300 to which the steering operation of the driver of vehicle 100 is input via a steering wheel 310, a steering apparatus 400 having a steering actuator that applies steering force to the road wheels (front road wheels 101 and 102) of vehicle 100, and a steering control apparatus 500.

Steering operation input apparatus 300 and steering apparatus 400 are mechanically separated from each other in steer-by-wire system 200.

In other words, steering wheel 310 is mechanically separated from front road wheels 101 and 102 in steer-by-wire system 200.

Steering operation input apparatus 300 includes steering wheel 310, a steering shaft 320, a reaction force motor 330, and an operation angle sensor 340.

Steering wheel 310 is a steering operation input member, which is operated by the driver of vehicle 100.

Reaction force motor 330 is a reaction force actuator (a first actuator), which is provided to apply steering reaction force torque to steering wheel 310 in the same way when the steering wheel and tires are connected.

That is, steering operation input apparatus 300 is an apparatus to which the steering operation of the driver is input via steering wheel 310, and includes reaction force motor 330, which applies steering reaction force torque to steering wheel 310.

Operation angle sensor 340 detects the turning angle of steering shaft 320 as an operation angle θ (in other words, the operation position) of steering wheel 310.

Specifically, operation angle sensor 340 detects the neutral position of steering wheel 310 as operation angle θ=0 degrees.

For example, when steering wheel 310 is operated to the left from the neutral position, operation angle sensor 340 detects the operation angle θ as a positive angle, and when steering wheel 310 is operated to the right from the neutral position, operation angle sensor 340 detects the operation angle θ as a negative angle.

Steering apparatus 400 includes a steering motor 410 as a steering actuator (a second actuator), a steering mechanism 420, which changes a steering angle δ of front road wheels 101 and 102 with the steering torque generated by steering motor 410, and a steering angle sensor 430, which detects steering angle δ of front road wheels 101 and 102.

Steering mechanism 420 is, for example, a mechanism that changes steering angle δ of front road wheels 101 and 102 by converting the rotational motion of steering motor 410 into a linear motion of a rack bar, based on a rack-and-pinion mechanism.

Steering angle sensor 430 is a sensor, which detects steering angle δ of front road wheels 101 and 102 by detecting the rotational position of steering motor 410 or the position of the rack bar of steering mechanism 420.

Specifically, steering angle sensor 430 detects the neutral position of front road wheels 101 and 102 as steering angle δ=0 degrees.

For example, when front road wheels 101 and 102 are steered to the left from the neutral position, steering angle sensor 430 detects steering angle δ as a positive angle, and when front road wheels 101 and 102 are steered to the right from the neutral position, steering angle sensor 430 detects steering angle δ as a negative angle.

The neutral position of front road wheels 101 and 102 is the position at which front road wheels 101 and 102 are not steered either to the right or left and at which vehicle 100 runs straight.

In addition, the neutral position of steering wheel 310 is the position at which steering wheel 310 is not steered either to the right or to the left and at which front road wheels 101 and 102 are at the neutral position.

Steering control apparatus 500 is an electronic control device including a MCU (Micro Controller Unit) 510, and controls the operation of steer-by-wire system 200.

In other words, MCU 510 may be referred to as a microcomputer, a processor, a processing device, an arithmetic device, or the like.

MCU 510 executes arithmetic processing with various kinds of signals acquired from the outside, so as to calculate a control signal for reaction force motor 330 and a control signal for steering motor 410, and outputs these calculated control signals.

That is, MCU 510 has a function as a control unit that outputs control signals to reaction force motor 330 and steering motor 410, in other words, has a function as a control unit that executes a steering control method.

Herein, steering control apparatus 500 may include a pre-driver, an inverter, etc., for controlling the current flowing through reaction force motor 330 and the current flowing through steering motor 410.

Separately from steering control apparatus 500, vehicle 100 may include a system including a drive circuit including a pre-driver, an inverter, etc.

Vehicle 100 includes a start switch 650, such as a power switch or an ignition switch, which starts various kinds of systems of vehicle 100, and steering control apparatus 500 acquires an ON/OFF signal of start switch 650.

Steer-by-wire system 200 is one of the systems started by start switch 650. When start switch 650 is turned ON, steer-by-wire system 200 is supplied with power and is consequently started. In this way, steer-by-wire system 200 is turned ON.

Vehicle 100 also includes wheel speed sensors 621 to 624 for detecting wheel speeds WS1 to WS4, which are the rotational speeds of road wheels 101 and 104.

MCU 510 acquires, for example, signals indicating physical quantities about wheel speeds WS1 to WS4 output by wheel speed sensors 621 to 624 (or a signal indicating a physical quantity about a vehicle speed VS calculated from the output of wheel speed sensors 621 to 624), a signal indicating a physical quantity about operation angle θ output by operation angle sensor 340, and a signal indicating a physical quantity about steering angle δ output by steering angle sensor 430.

MCU 510 calculates a steering angle command value Stg, which is the target value of steering angle δ, based on information about operation angle θ of steering wheel 310.

In addition, MCU 510 calculates a control signal based on the difference between steering angle δ detected by steering angle sensor 430 and steering angle command value δtg, and outputs the calculated control signal to steering motor 410.

In addition, MCU 510 calculates a reaction force torque command value TRtg, which is the target value of a reaction force torque TR, based on vehicle speed VS calculated from wheel speeds WS1 to WS4 and the information about operation angle θ of steering wheel 310, for example.

MCU 510 can calculate vehicle speed VS by acquiring the signals of wheel speeds WS1 to WS4 from wheel speed sensors 621 to 624. MCU 510 may acquire information about vehicle speed VS, which has been calculated by another electronic control device based on the signals of wheel speeds WS1 to WS4, via an in-vehicle network.

Next, MCU 510 outputs a control signal based on reaction force torque command value TRtg to reaction force motor 330.

In this way, MCU 510 controls the operation of steer-by-wire system 200 by controlling the steering force applied to front road wheels 101 and 102 and by controlling reaction force torque applied to steering wheel 310.

Since steering wheel 310 and front road wheels 101 and 102 are mechanically separated from each other in steer-by-wire system 200, the operation position of steering wheel 310 and steering angle δ of front road wheels 101 and 102 could be statically deviated from each other.

To resolve this deviation, when steer-by-wire system 200 is turned ON, if a deviation amount AD of steering angle δ of front road wheels 101 and 102 with respect to operation angle θ of steering wheel 310 is equal to or greater than a tolerable amount TD, MCU 510 executes alignment control, specifically, actively changes operation angle θ or steering angle δ with an actuator such that deviation amount AD is reduced.

Deviation amount AD is an error of actual steering angle δ with respect to steering angle command value Stg unambiguously determined based on operation angle θ of steering wheel 310.

When MCU 510 actively changes operation angle θ in the alignment control, MCU 510 causes reaction force motor 330 to generate rotational drive force that rotates steering wheel 310 to a position matching steering angle δ.

By executing the above-described alignment control, after the alignment, the operation position of steering wheel 310 matches steering angle δ, and the driver's steering operability is improved.

Herein, MCU 510 determines whether to actively change operation angle θ or steering angle δ in the alignment control, based on the physical quantity about vehicle speed VS.

In other words, MCU 510 switches execution of the alignment control for actively changing the position of steering wheel 310 with reaction force motor 330 (this alignment control will be hereinafter referred to as “first alignment control”) and execution of the alignment control for actively changing steering angle δ of front road wheels 101 and 102 with steering motor 410 (this alignment control will be hereinafter referred to as “second alignment control”), based on the physical quantity about vehicle speed VS.

Hereinafter, why MCU 510 switches execution of the first alignment control and execution of the second alignment control based on the condition of vehicle speed VS will be described.

The following description assumes that MCU 510 executes the second alignment control that actively changes steering angle δ (in other words, the direction of tires) when vehicle 100 is in the stopped state.

For example, when vehicle 100 is stopped and a worker is doing maintenance work on the suspension or tires of front road wheels 101 and 102 at a maintenance facility, if start switch 650 such as ignition switch IGN-SW is turned ON, steer-by-wire system 200 is turned ON, and the second alignment control is consequently started, the direction of the tires could unexpectedly change. That is, there is a possibility that the worker may not be able to perform the maintenance work smoothly and safely.

In addition, after the user of vehicle 100 parks vehicle 100, if start switch 650 is turned ON and the alignment control is started, the direction of the tires could unexpectedly change. In this case, a tire could come into contact with a movable object located near one of front road wheels 101 and 102, which are the steered road wheels, and the movable object could move unexpectedly, or the movable object could be sandwiched between a fixed object such as a wall and the tire.

These concerns about the second alignment control executed when vehicle 100 is in the stopped state are avoidable by adopting the first alignment control that actively changes the position of steering wheel 310.

However, if the driver starts moving vehicle 100 while holding steering wheel 310 before the alignment based on the first alignment control is complete, because the first alignment control aligns the operation position of steering wheel 310 to steering angle δ, vehicle 100 consequently starts moving with the deviation between the operation position of steering wheel 310 and steering angle δ. As a result, vehicle behavior not expected by the driver may occur.

Thus, steering control apparatus 500 switches execution of the first alignment control and execution of the second alignment control, based on the condition of vehicle speed VS, so as to prevent the alignment control executed when steer-by-wire system 200 is turned ON from negatively affecting vehicle maintenance and vehicle driving.

That is, both the state in which maintenance work is being performed on vehicle 100 at a maintenance facility and the state in which vehicle 100 is parked are the stopped state of vehicle 100.

In the stopped state, if the alignment based on the first alignment control is executed, since the direction of tires does not change, it is possible to prevent trouble from occurring in the maintenance work on the suspension, etc., and to prevent a movable object present near parked vehicle 100 from being pressed by a tire or sandwiched between another object and a tire.

After vehicle 100 starts moving and shifts to the running state, if the alignment based on the second alignment control is executed, that is, if the alignment based on the second control mode is executed, because steering angle δ is aligned to operation angle θ (in other words, the direction of the tires is aligned to the operation position of steering wheel 310), it is possible to prevent vehicle 100 from running in a direction not intended by the driver.

Thus, when steer-by-wire system 200 is turned ON and the alignment control is executed, steering control apparatus 500 compares vehicle speed VS with a threshold VSTH used for determining which alignment control needs to be executed.

If vehicle speed VS is equal to or less than threshold VSTH, steering control apparatus 500 selects the first alignment control. If vehicle speed VS is greater than threshold VSTH, steering control apparatus 500 selects the second alignment control.

Threshold VSTH is set to 0 km/h or a very low vehicle speed. Thus, the state in which vehicle speed VS is equal to or less than threshold VSTH is equivalent to the stopped state of vehicle 100, and the state in which vehicle speed VS is greater than threshold VSTH is equivalent to the running state of vehicle 100.

That is, when steer-by-wire system 200 is turned ON, if vehicle 100 is in the stopped state in which vehicle speed VS is equal to or less than threshold VSTH, steering control apparatus 500 executes the first alignment control. On the other hand, if vehicle 100 is in the running state in which vehicle speed VS is greater than threshold VSTH, steering control apparatus 500 executes the second alignment control.

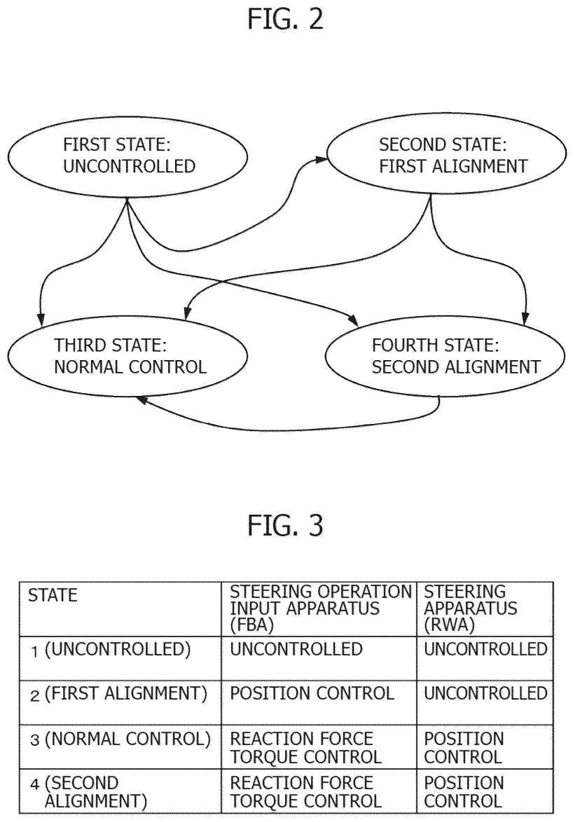

FIG. 2 illustrates the alignment control state transition executed by steering control apparatus 500.

FIG. 3 illustrates the control states of steering operation input apparatus 300 and steering apparatus 400 in the individual states illustrated in FIG. 2.

The control states in FIG. 2 include a first state, which is an initial uncontrolled state immediately after steer-by-wire system 200 is started, a second state in which the first alignment control is executed, a third state in which a normal steering control is executed, and a fourth state in which the second alignment control is executed.

When start switch 650 is turned ON and steer-by-wire system 200 is consequently turned ON, that is, in an initial state immediately after steering control apparatus 500 is started, steering control apparatus 500 is set in the first state.

The first state is the state in which drive control of reaction force motor 330 and steering motor 410 is stopped, in other words, a state in which reaction force motor 330 and steering motor 410 are not controlled.

In this first state, steering control apparatus 500 calculates deviation amount AD [deg] of steering angle δ of front road wheels 101 and 102 with respect to steering angle command value Stg based on operation angle θ of steering wheel 310, and compares calculated deviation amount AD with tolerable amount TD.

If deviation amount AD is equal to or greater than tolerable amount TD, and if vehicle 100 is in the stopped state in which vehicle speed VS is equal to or less than threshold VSTH, steering control apparatus 500 shifts the control state to the second state.

Deviation amount AD is the absolute value of the deviation angle.

The second state is the state in which the first alignment control is executed.

In this state, steering control apparatus 500 controls the rotational drive force that reaction force motor 330 applies to the steering wheel 310 such that operation angle θ of steering wheel 310 will change to an angle matching steering angle δ of front road wheels 101 and 102.

In the first alignment control, steering control apparatus 500 maintains steering motor 410 in a drive stop state (in other words, an uncontrolled state).

In the first alignment control, steering control apparatus 500 controls the torque that reaction force motor 330 applies to steering wheel 310 and controls the rotational speed of steering wheel 310.

Specifically, steering control apparatus 500 controls the rotational torque applied by reaction force motor 330 to such an extent that the driver can operate steering wheel 310 against the rotational torque applied by reaction force motor 330.

In addition, steering control apparatus 500 controls the rotational speed of steering wheel 310 to such an extent that an impact is not given to the driver as steering wheel 310 automatically rotates and comes into contact with the driver's hands, for example.

When executing the first alignment control, steering control apparatus 500 activates a warning device 640 installed in vehicle 100, and notifies the driver of vehicle 100 of the execution of the alignment control (or a minor failure of steer-by-wire system 200).

Warning device 640 is a warning lamp, a liquid crystal display device, an audio guidance device, or the like.

With this warning by warning device 640, the driver can recognize the execution of the alignment control, and can be prevented from being disturbed by the automatic rotation of steering wheel 310.

In addition, delaying the driver's operation to start moving vehicle 100 with the warning by warning device 640 contributes to completion of the alignment in the stopped state.

As described above, by executing the first alignment control in the stopped state of vehicle 100, it is possible to change operation angle θ of steering wheel 310 while maintaining steering angle δ of front road wheels 101 and 102. Thus, even when the alignment control is executed during maintenance work on the suspension, etc., at a maintenance facility, steering angle δ of front road wheels 101 and 102 does not change unexpectedly, and the maintenance work can be conducted smoothly and safely.

In addition, even when the alignment is performed after the user of vehicle 100 parks vehicle 100, because steering angle δ of front road wheels 101 and 102 does not change, a movable object located near front road wheels 101 and 102 does not interfere with any of the tires.

In the first state, if steering control apparatus 500 determines that deviation amount AD is less than tolerable amount TD, that is, steering angle δ of front road wheels 101 and 102 matches operation angle θ of steering wheel 310, and if there is no deviation needing a correction operation, steering control apparatus 500 shifts the control state to the third state, regardless of the condition of vehicle speed VS (in other words, whether vehicle 100 is in the stopped state or running state).

The third state is the normal steering state in which the normal control of reaction force motor 330 and steering motor 410 is executed.

That is, in the third state, steering control apparatus 500 controls reaction force motor 330 such that reaction force motor 330 generates steering reaction force in the same way when the steering wheel and tires are connected, and controls steering motor 410 such that steering angle δ of front road wheels 101 and 102 matches operation angle θ of steering wheel 310.

In addition, as a result of the execution of the first alignment control in the second state, if deviation amount AD falls below tolerable amount TD, that is, if the alignment based on the first alignment control is complete, steering control apparatus 500 shifts the control state to the third state, and executes the normal control of reaction force motor 330 and steering motor 410.

As described above, when steering control apparatus 500 executes the first alignment control in the stopped state of vehicle 100, and when deviation amount AD falls below tolerable amount TD, steering control apparatus 500 shifts the control state to the normal steering control state in which reaction force motor 330 applies steering reaction force torque to steering wheel 310 and in which steering motor 410 applies steering force based on operation angle θ, which is the information about the operation of steering wheel 310, to front road wheels 101 and 102.

During execution of the first alignment control in the second state and before this alignment based on the first alignment control is complete, that is, before deviation amount AD falls below tolerable amount TD, if steering control apparatus 500 detects that vehicle 100 has started moving, steering control apparatus 500 shifts the control state to the fourth state.

Detection of the start of moving of vehicle 100 is detection of vehicle speed VS greater than threshold VSTH, in other words, detection of the transition from the stopped state of vehicle 100 to the running state of vehicle 100 or detection of input of a vehicle speed signal.

The fourth state is the state in which the second alignment control is executed.

Steering control apparatus 500 controls the steering force that steering motor 410 applies to front road wheels 101 and 102 such that steering angle δ of front road wheels 101 and 102 promptly changes to an angle matching operation angle θ of steering wheel 310.

In addition, in the second alignment control in the fourth state, steering control apparatus 500 causes reaction force motor 330 to generate steering reaction force in the same way when the steering wheel and tires are connected.

That is, if vehicle 100 starts moving during the first alignment control, steering control apparatus 500 switches the alignment control from the first alignment control to the second alignment control.

Thus, if vehicle 100 starts moving while the driver is holding steering wheel 310, steering angle δ of front road wheels 101 and 102 is changed to an angle that matches the position of held steering wheel 310, and as a result, generation of vehicle behavior not intended by the driver is prevented.

In addition, in the second alignment control, since steering control apparatus 500 causes reaction force motor 330 to apply reaction force torque to steering wheel 310, the position of steering wheel 310 is not easily moved, and operability at the start of moving of vehicle 100 can be stabilized.

As is the case with the first alignment control, steering control apparatus 500 activates warning device 640 while executing the second alignment control.

As a result of the execution of the second alignment control in the fourth state, if deviation amount AD falls below tolerable amount TD, that is, if the alignment in the second alignment control is complete, steering control apparatus 500 shifts the control state to the third state, and executes the normal control of reaction force motor 330 and steering motor 410.

That is, if deviation amount AD falls below tolerable amount TD as a result of the execution of the second alignment control in the running state of vehicle 100, steering control apparatus 500 shifts the control state to the normal steering control state in which reaction force motor 330 applies reaction force torque to steering wheel 310, and steering motor 410 applies steering force based on operation angle θ of steering wheel 310 to front road wheels 101 and 102.

In addition, in the first state (specifically, in the initial uncontrolled state immediately after steer-by-wire system 200 is started), if steering control apparatus 500 determines that deviation amount AD is equal to or greater than tolerable amount TD, and that vehicle 100 is in the running state in which vehicle speed VS is greater than threshold VSTH, steering control apparatus 500 shifts the control state to the fourth state, and executes the second alignment control.

That is, if vehicle 100 is moving in the initial state immediately after steer-by-wire system 200 is started, steering control apparatus 500 immediately executes the second alignment control, without executing the first alignment control.

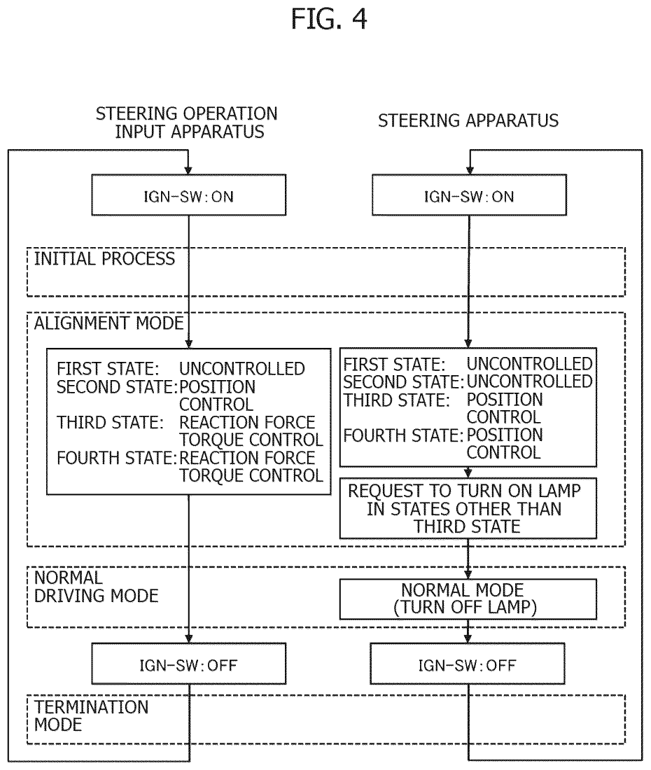

FIG. 4 is a flowchart illustrating a control flow of steer-by-wire system 200 executed by steering control apparatus 500, the control flow including the alignment controls described above with reference to FIGS. 2 and 3.

The flowchart in FIG. 4 separately illustrates the control process of steering operation input apparatus 300 and the control process of steering apparatus 400, each of these control processes includes an initial process, an alignment mode, a normal driving mode, and a termination mode.

When start switch 650 such as ignition switch IGN-SW is turned ON and steer-by-wire system 200 is consequently turned ON, steering control apparatus 500 executes the initial process for each of steering operation input apparatus 300 and steering apparatus 400.

Next, steering control apparatus 500 shifts the mode to the alignment mode, that is, shifts to one of the above-described first state, second state, third state, and fourth state, based on the conditions of deviation amount AD and vehicle speed VS.

As described above, the first state is the initial uncontrolled state immediately after steer-by-wire system 200 is started, the second state is the state in which the first alignment control is executed, the third state is the state in which the normal steering control is executed after completion of the alignment, and the fourth state is the state in which the second alignment control is executed.

In the first state, steering operation input apparatus 300 is set in the uncontrolled state, and in the second state, steering operation input apparatus 300 is set in a position control state in which reaction force motor 330 is controlled such that operation angle θ matches steering angle δ.

In addition, in the third state and the fourth state, steering operation input apparatus 300 is set in a torque control state in which reaction force motor 330 applies steering reaction force torque to steering wheel 310.

On the other hand, in the first state and the second state, steering apparatus 400 is set in the uncontrolled state, and in the third state and the fourth state, steering apparatus 400 is set in a position control state in which steering motor 410 is controlled such that steering angle δ matches operation angle θ.

In addition, in the alignment mode, in states other than the third state, steering control apparatus 500 activates warning device 640. For example, steering control apparatus 500 turns on a warning lamp.

Although steering control apparatus 500 does not execute the alignment control in the first state, because the first state is a branch point of whether to execute the alignment or not, steering control apparatus 500 activates warning device 640 in the first state. Even when the control state is shifted from the first state to the second state or the fourth state, steering control apparatus 500 keeps warning device 640 activated.

When the alignment in the second state or the fourth state is complete and the control state is consequently shifted to the third state, or when the control state is shifted from the first state to the third state, steering control apparatus 500 shifts the present mode to the normal driving mode, and stops the activation of warning device 640.

Next, when start switch 650 such as ignition switch IGN-SW is turned OFF, steering control apparatus 500 shifts the mode to the termination mode, executes a predetermined termination process, and shuts off.

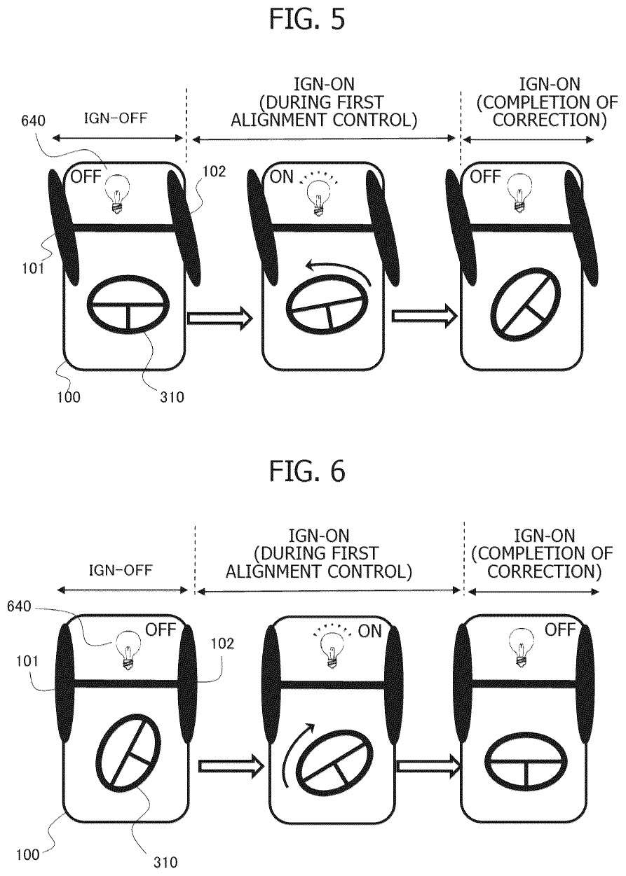

FIGS. 5 and 6 illustrate how steering angle δ and operation angle θ change in the first alignment control.

FIG. 5 illustrates how the first alignment control aligns operation angle θ to steering angle δ when steering angle δ of front road wheels 101 and 102 has been shifted to the left from the straight position (in other words, the neutral position), and when operation angle θ of steering wheel 310 corresponds to approximately the neutral position.

In this case, when ignition switch IGN-SW as start switch 650 is turned ON and steer-by-wire system 200 is consequently turned ON, steering control apparatus 500 causes reaction force motor 330 to rotate steering wheel 310 counterclockwise, so as to change operation angle θ of steering wheel 310 to an angle corresponding a position rotated to the left of the neutral position, the position matching steering angle δ.

While rotating steering wheel 310 with the rotational drive force of reaction force motor 330, steering control apparatus 500 holds steering motor 410 in the uncontrolled state and holds steering angle δ at its initial angle.

In addition, while executing the alignment based on the first alignment control, in other words, while actively changing operation angle θ of steering wheel 310, steering control apparatus 500 activates warning device 640 such as a warning lamp, so as to warn the driver of vehicle 100 that the alignment is being executed.

FIG. 6 illustrates how the first alignment control aligns operation angle θ to steering angle δ when steering angle δ of front road wheels 101 and 102 corresponds to approximately the straight position and when operation angle θ of steering wheel 310 has been shifted to the left from the neutral position.

In this case, when ignition switch IGN-SW as start switch 650 is turned ON and steer-by-wire system 200 is consequently turned ON, steering control apparatus 500 causes reaction force motor 330 to rotate steering wheel 310 clockwise, so as to change operation angle θ of steering wheel 310 to the angle of the neutral position matching steering angle δ.

During this alignment, too, by holding steering motor 410 in the uncontrolled state, steering control apparatus 500 holds steering angle δ at its initial angle, that is, holds steering angle δ at the angle of the neutral position, and activates warning device 640.

Since the first alignment control is executed in the stopped state of vehicle 100, the direction of front road wheels 101 and 102 does not change unexpectedly in the stopped state of vehicle 100. Even when steer-by-wire system 200 is turned ON when maintenance work is being conducted or when a movable object is present near front road wheels 101 and 102, the maintenance work or the movable object is not negatively affected.

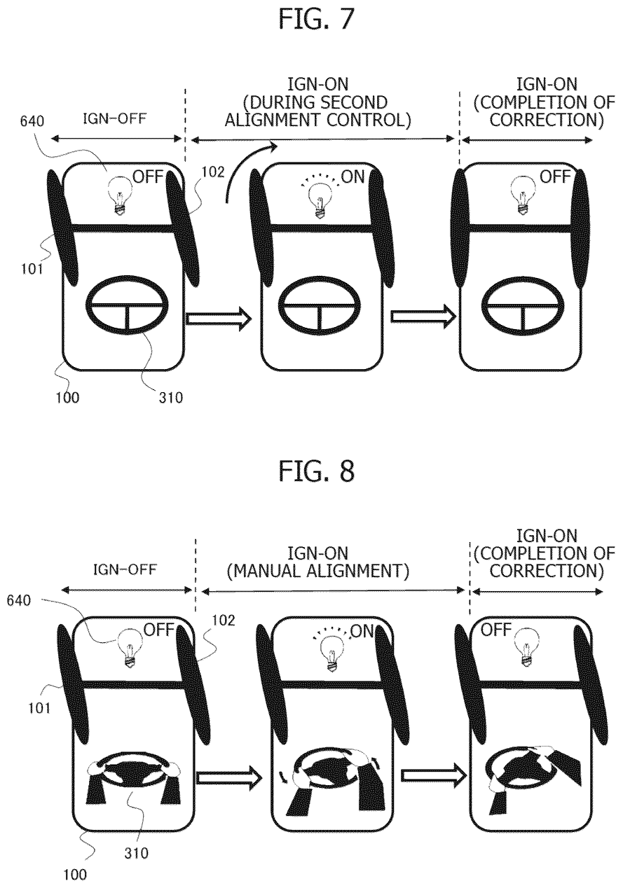

FIGS. 7 and 8 illustrate how steering angle δ and operation angle θ change in the second alignment control.

FIG. 7 illustrates how the second alignment control aligns steering angle δ to operation angle θ when steering angle δ of front road wheels 101 and 102 has been shifted to the left from the straight position (in other words, the neutral position), and when operation angle θ of steering wheel 310 corresponds to approximately the neutral position.

In this case, by controlling the steering force generated by steering motor 410, steering control apparatus 500 changes steering angle δ of front road wheels 101 and 102 to the angle of the neutral position.

FIG. 8 illustrates how the second alignment control aligns operation angle θ to steering angle δ when steering angle δ of front road wheels 101 and 102 corresponds to approximately the straight position and when operation angle θ of steering wheel 310 has been shifted to the left from the neutral position.

In this case, by controlling the steering force generated by steering motor 410, steering control apparatus 500 changes steering angle δ of front road wheels 101 and 102 from the neutral position to an angle shifted to the left, the angle matching operation angle θ of steering wheel 310.

As illustrated in FIGS. 7 and 8, since the second alignment control actively changes steering angle δ of front road wheels 101 and 102, when the second alignment control is executed in the stopped state, maintenance work on front road wheels 101 and 102 or a movable object located near front road wheels 101 and 102 could be affected negatively.

However, steering control apparatus 500 executes the first alignment control when vehicle 100 is in the stopped state, and switches the alignment control to the second alignment control when vehicle 100 is shifted to the running state. Thus, in the stopped state, the alignment control is prevented from negatively affecting maintenance work or a movable object located near front road wheels 101 and 102.

In addition, because steering control apparatus 500 executes the second alignment control when vehicle 100 is in the running state, and promptly executes a correction operation such that steering angle δ matches operation angle θ of steering wheel 310, it is possible to prevent occurrence of vehicle behavior not intended by the driver.

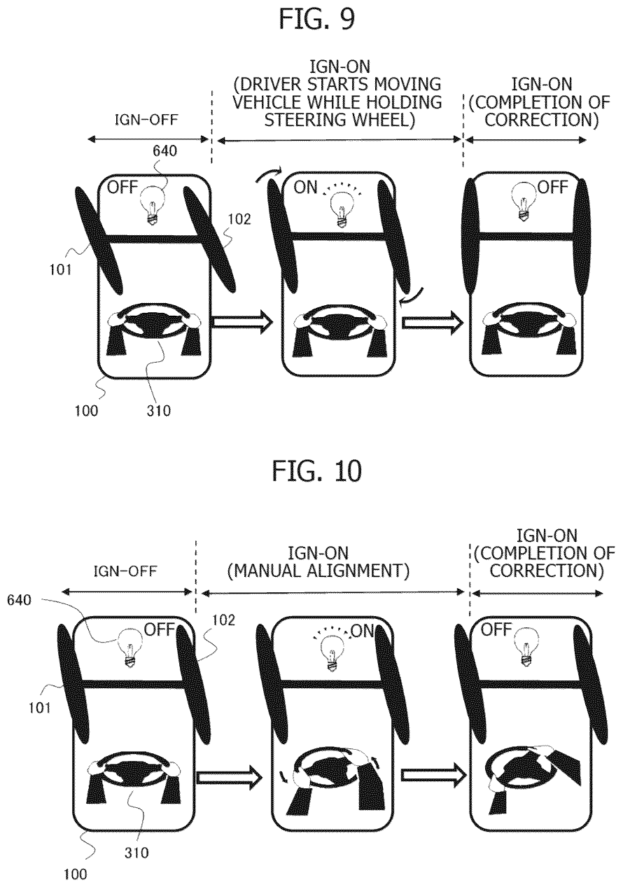

FIG. 9 illustrates how the second alignment control changes steering angle δ when there is deviation amount AD between operation angle θ and steering angle δ and when the driver has started to move vehicle 100 while holding steering wheel 310.

In FIG. 9, although steering wheel 310 is approximately at the neutral position, front road wheels 101 and 102 have been steered to the left from the straight position.

Thus, steering control apparatus 500 executes the second alignment control in response to the start of moving of vehicle 100, that is, in response to the transition from the stopped state to the running state. That is, steering control apparatus 500 shifts the control state to the fourth state, and controls the steering force of steering motor 410 such that steering angle δ of front road wheels 101 and 102 changes to an angle matching the straight position.

In this way, vehicle 100 is prevented from turning left, against the driver's intention to drive vehicle 100 straight by holding steering wheel 310 at the neutral position.

As described above, in the first alignment control, steering control apparatus 500 controls the rotational torque applied by reaction force motor 330 to such an extent that the driver can operate steering wheel 310 against the rotational torque applied by reaction force motor 330.

Thus, in the first alignment control, the driver's intervention to change operation angle θ is permitted. That is, the driver can manually execute the alignment.

FIG. 10 illustrates how the alignment is executed manually in the second state in which the first alignment control is executed.

FIG. 10 illustrates how the alignment is executed manually when steering wheel 310 is near the neutral position, and steering angle δ of front road wheels 101 and 102 has been shifted to the left from the neutral position.

When vehicle 100 is in the stopped state, the first alignment control is executed, and reaction force motor 330 applies rotational drive force to steering wheel 310. At this point, the driver can manually execute the alignment by rotating steering wheel 310 in the left direction.

In this case, when the alignment is complete, warning device 640 is deactivated (for example, a warning lamp is turned OFF). As a result, the driver can recognize the completion of the alignment, and can stop rotating steering wheel 310 when operation angle θ matches steering angle δ.

In addition, when the alignment is complete, and when the control state is shifted from the second state in which the first alignment control is executed to the third state in which the normal control is executed, because reaction force motor 330 starts to generate reaction force against the driver's operation of steering wheel 310, the driver's excessive steering operation is controlled.

In addition, if the driver starts moving vehicle 100 during the manual alignment, the controls state is shifted to the fourth state, that is, the second alignment control is executed.

Thus, steering motor 410 generates steering force such that steering angle δ of front road wheels 101 and 102 matches operation angle θ of steering wheel 310.

As described above, steering control apparatus 500 can shift the control state from the second state (the first alignment control) to the fourth state (the second alignment control) based on vehicle speed VS, and can shift the control state from the second state (the first alignment control) to the fourth state (the second alignment control), based on switching of the shift position (in other words, the driving mode) of the automatic transmission constituting the power transmission system of vehicle 100.

If the driver starts moving vehicle 100 from the stopped state (specifically, starts moving vehicle 100 forward or backward), the driver executes a shift operation to change the shift position of the automatic transmission from parking range P or neutral range N to a driving range such as drive range D or reverse range R.

Thus, if the driver executes a shift operation to change from parking range P or neutral range N to drive range D, reverse range R, or the like, steering control apparatus 500 determines this shift operation to be preparation for starting, and shifts the control state from the second state (the first alignment control) to the fourth state (the second alignment control), without waiting for vehicle 100 to actually start.

Thus, if the driver starts moving vehicle 100 during the first alignment control, the second alignment control for aligning steering angle δ to operation angle θ is started more promptly. Consequently, the deviation is corrected more rapidly, and occurrence of vehicle behavior not intended by the driver is more reliably prevented.

In addition, steering control apparatus 500 may use the duration time of the first alignment control as a condition for shifting the control state from the second state (the first alignment control) to the fourth state (the second alignment control).

For example, the maximum time needed for the alignment based on the first alignment control can be estimated from an anticipated maximum deviation amount. If the first alignment control continues over this maximum time, it is estimated that some failure is preventing the alignment for actively moving the operation position of steering wheel 310.

Thus, if the duration time of the first alignment control exceeds a setting time, steering control apparatus 500 determines that the alignment based on the first alignment control is impossible, and shifts the control state to the fourth state (the second alignment control).

If reaction force motor 330 continuously generates rotational drive force although the alignment based on the first alignment control is impossible, reaction force motor 330 or a drive circuit of reaction force motor 330 may become overheated. However, occurrence of this problem can be prevented by using the duration time.

In addition, even when the alignment based on the first alignment control is impossible, deviation amount AD can be reduced by the time that vehicle 100 starts moving, and occurrence of vehicle behavior not intended by the driver can be prevented.

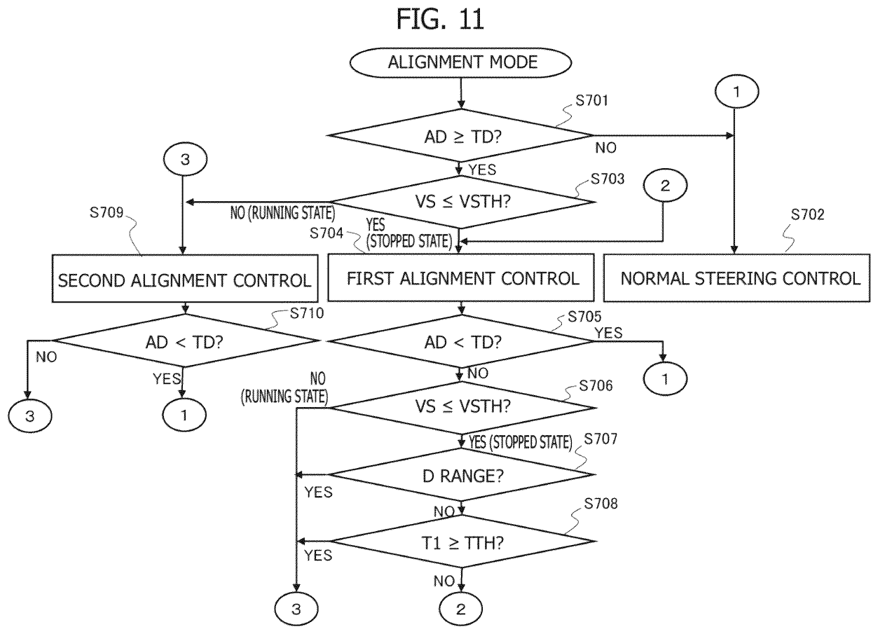

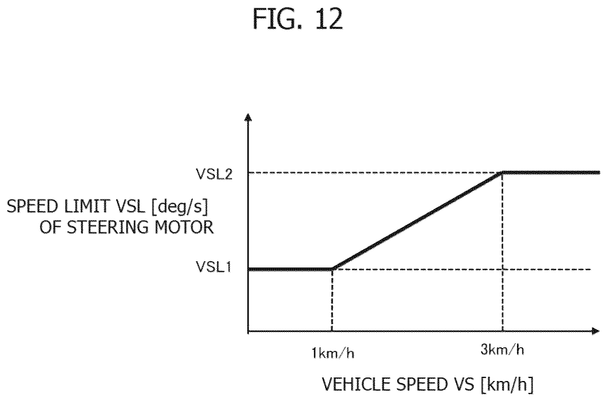

FIG. 11 is a flowchart illustrating a process flow in the alignment mode in which switching of the shift position of the automatic transmission and the duration time of the first alignment control are added as conditions for shifting the control state from the second state (the first alignment control) to the fourth state (the second alignment control).

When start switch 650 is turned ON and steer-by-wire system 200 is turned ON, steering control apparatus 500 is consequently started. First, in step S701, steering control apparatus 500 determines whether deviation amount AD is equal to or greater than tolerable amount TD.

In this step, if steering control apparatus 500 determines that deviation amount AD is less than tolerable amount TD and that deviation amount AD is not large enough to execute the alignment process, the processing proceeds to step S702.

In step S702, steering control apparatus 500 executes the normal control of reaction force motor 330 and steering motor 410.

In other words, in step S702, steering control apparatus 500 shifts the control state from the first state (the uncontrolled state) to the third state (the normal steering control).

However, if steering control apparatus 500 determines that deviation amount AD is equal to or greater than tolerable amount TD and that the alignment control needs to be executed, the processing proceeds to step S703.

In step S703, steering control apparatus 500 compares vehicle speed VS with threshold VSTH, so as to determine whether vehicle 100 is in the stopped state or the running state.

If steering control apparatus 500 determines that vehicle speed VS is equal to or less than threshold VSTH and that vehicle 100 is in the stopped state, the processing proceeds to step S704.

In step S704, steering control apparatus 500 executes the first alignment control. In other words, in step S704, steering control apparatus 500 shifts the control state from the first state (the uncontrolled state) to the second state (the first alignment control).

After shifting the control state to the second state (the first alignment control), in next step S705, steering control apparatus 500 determines whether deviation amount AD becomes less than tolerable amount TD, that is, whether the alignment is complete.

If steering control apparatus 500 determines that deviation amount AD becomes less than tolerable amount TD as a result of the first alignment control, the processing proceeds to step S702.

In step S702, steering control apparatus 500 executes the normal control of reaction force motor 330 and steering motor 410. In other words, in step S702, steering control apparatus 500 shifts the control state from the second state (the first alignment control) to the third state (the normal steering control).

However, if steering control apparatus 500 determines that deviation amount AD is still equal to or greater than tolerable amount TD, the processing proceeds to step S706.

In step S706, steering control apparatus 500 determines whether vehicle 100 has shifted from the stopped state to the running state by determining whether vehicle speed VS is equal to or less than threshold VSTH.

If steering control apparatus 500 determines that vehicle speed VS is equal to or greater than threshold VSTH and that vehicle 100 has shifted from the stopped state to the running state, the processing proceeds to step S709, and steering control apparatus 500 executes the second alignment control.

In other words, if steering control apparatus 500 detects that vehicle 100 has started moving in the second state in which the first alignment control is executed, steering control apparatus 500 shifts the control state from the second state (the first alignment control) to the fourth state (the second alignment control).

If steering control apparatus 500 determines that vehicle speed VS is equal to or less than threshold VSTH and that vehicle 100 is still in the stopped state, the processing proceeds to step S707.

In step S707, steering control apparatus 500 acquires a signal of a shift position sensor 630 for detecting the shift position (the driving mode) of the automatic transmission of vehicle 100, and determines whether the shift position has changed from parking range P or neutral range N to drive range D or reverse range R.

Next, if steering control apparatus 500 detects change in shift position from parking range P or neutral range N to drive range D or reverse range R, the processing proceeds to step S709, and steering control apparatus 500 executes the second alignment control.

In other words, if steering control apparatus 500 detects change in shift position from parking range P or neutral range N to drive range D or reverse range R, steering control apparatus 500 shifts the control state from the second state (the first alignment control) to the fourth state (the second alignment control).

That is, if the driver changes the shift position from parking range P or neutral range N to drive range D or reverse range R, it is highly likely that the driver will start moving vehicle 100 In this way, if the driver changes the shift position from parking range P or neutral range N to drive range D or reverse range R, steering control apparatus 500 assumes that the driver will start moving vehicle 100, and shifts the control state from the first alignment control to the second alignment control, without waiting for vehicle 100 to actually start moving.

If steering control apparatus 500 does not detect change in shift position from parking range P or neutral range N to drive range D or reverse range R, the processing proceeds to step S708.

In step S708, steering control apparatus 500 determines whether duration time T1, which is the time for which the first alignment control has been executed continuously, is equal to or greater than a predetermined time TTH.

If steering control apparatus 500 determines that duration time T1 is equal to or greater than predetermined time TTH, that is, determines that the alignment based on the first alignment control is not yet complete even after elapse of time in which completion of the alignment is expected, the processing proceeds to step S709, and steering control apparatus 500 executes the second alignment control.

In this way, if the alignment is not yet complete even after the first alignment control has been executed continuously for predetermined time TTH, steering control apparatus 500 shifts the control state from the second state (the first alignment control) to the fourth state (the second alignment control), even if the stopped state is still maintained.

However, if duration time T1 is less than predetermined time TTH, the processing returns to step S704, steering control apparatus 500 continues the execution of the first alignment control (in the second state).

In step S710, steering control apparatus 500 determines whether deviation amount AD becomes less than tolerable amount TD while executing the second alignment control.

If deviation amount AD becomes less than tolerable amount TD by the second alignment control, the processing proceeds to step S702, and steering control apparatus 500 executes the normal control of reaction force motor 330 and steering motor 410.

In other words, if deviation amount AD becomes less than tolerable amount TD by the second alignment control, steering control apparatus 500 shifts the control state from the fourth state (the second alignment control) to the third state (the normal steering control).

If deviation amount AD is still equal to or greater than tolerable amount TD, the processing returns to step S709, and steering control apparatus 500 continues the execution of the second alignment control.

Steering control apparatus 500 can reduce the sense of discomfort in operability felt by the driver immediately after vehicle 100 starts moving, by setting a higher rotational speed (the operation speed) of steering motor 410 for higher vehicle speed VS (in other words, for a greater physical quantity about the vehicle speed) in the second alignment control.

For example, based on vehicle speed VS, steering control apparatus 500 changes the speed limit (upper speed limit) in the control of steering motor 410 in the second alignment control. That is, steering control apparatus 500 increases the rotational speed, that is, the steering speed, of steering motor 410, as vehicle speed VS increases. In this way, steering control apparatus 500 can complete the alignment more promptly as vehicle speed VS increases.

FIG. 12 is a graph illustrating a mode of the correlation between the speed limit of steering motor 410 and vehicle speed VS in the second alignment control.

Based on the characteristics example in FIG. 12, a speed limit VSL is maintained at a first speed limit VSL1 in a speed range in which vehicle speed VS is between 0 km/h and 1 km/h.

In addition, in a speed range in which vehicle speed VS is between 1 km/h and 3 km/h, speed limit VSL gradually increases from first speed limit VSL1 to a second speed limit VSL2 (VSL2>VSL1) as vehicle speed VS increases.

In addition, in a speed range in which vehicle speed VS is 3 km/h or greater, speed limit VSL is maintained at second speed limit VSL2.

In the second alignment control, steering control apparatus 500 sets speed limit VSL based on a detected value of vehicle speed VS, as illustrated by the characteristics in FIG. 12, and drives steering motor 410 such that the rotational speed of steering motor 410 does not exceed speed limit VSL.

Herein, steering control apparatus 500 sets higher speed limit VSL for higher vehicle speed VS. In this way, when vehicle 100 is in a very low speed range immediately after starting to move, steering control apparatus 500 can prevent occurrence of squealing sounds due to sudden change in direction of front road wheels 101 and 102. In addition, when vehicle speed VS increases, steering control apparatus 500 can correct deviation amount AD quickly, and can consequently prevent occurrence of vehicle behavior not intended the driver.

In addition, steering control apparatus 500 can perform switching between the first alignment control and the second alignment control based on an accelerator operation amount, which is a physical quantity correlated to vehicle speed VS, instead of based on vehicle speed VS.

In other words, instead of vehicle speed VS, steering control apparatus 500 can use the physical quantity about the accelerator operation amount, as a state amount of vehicle 100 used for determining whether vehicle 100 is in the stopped state or the running state.

In this case, steering control apparatus 500 directly acquires the physical quantity about an accelerator operation amount AC from an accelerator operation amount sensor 660, which detects accelerator operation amount AC, or from an in-vehicle network.

Next, steering control apparatus 500 compares acquired accelerator operation amount AC with a threshold ACTH.

Threshold ACTH is set to a value such that accelerator operation amount AC does not exceed threshold ACTH when vehicle 100 is in the stopped state and exceeds threshold ACTH when vehicle 100 is in the running state.

Steering control apparatus 500 executes the first alignment control when the physical quantity about accelerator operation amount AC is equal to or less than threshold ACTH and when it is estimated that vehicle 100 is in the stopped state.

In addition, steering control apparatus 500 executes the second alignment control when the physical quantity about accelerator operation amount AC is greater than threshold ACTH and when it is estimated that vehicle 100 is in the running state.

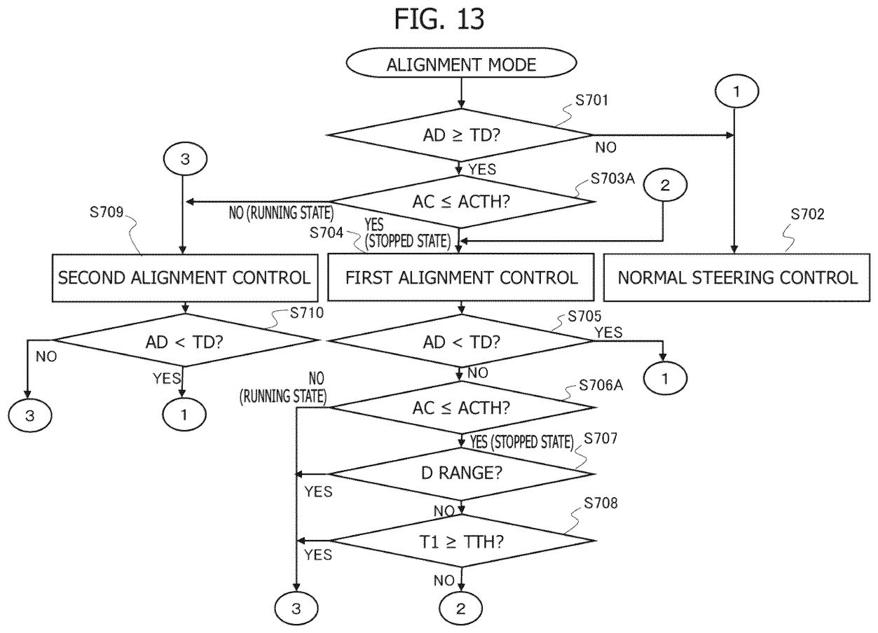

FIG. 13 is a flowchart illustrating a process flow in the alignment mode in which the process for determining whether vehicle 100 is in the stopped state or the running state based on accelerator operation amount AC is adopted.

The flowchart in FIG. 13 differs from the flowchart in FIG. 11 in step S703A and step S706A. The other steps in FIG. 13 are the same as those in FIG. 11.

Thus, step S703A and step S706A will be hereinafter described, and description of the other steps will be omitted.

In step S703A, steering control apparatus 500 determines whether accelerator operation amount AC is equal to or less than threshold ACTH.

In step S703A, if steering control apparatus 500 determines that accelerator operation amount AC is equal to or less than threshold ACTH and that vehicle 100 is in the stopped state, the processing proceeds to step S704. If steering control apparatus 500 determines that accelerator operation amount AC is greater than threshold ACTH and vehicle 100 is in the running state, the processing proceeds to step S709.

Similarly, in step S706A, steering control apparatus 500 determines whether accelerator operation amount AC is equal to or less than threshold ACTH.

In step S706A, if steering control apparatus 500 determines that accelerator operation amount AC is equal to or less than threshold ACTH, the processing proceeds to step S707.

If steering control apparatus 500 determines that accelerator operation amount AC is greater than threshold ACTH, the processing proceeds to step S709.

If steering control apparatus 500 determines that vehicle 100 is in the stopped state or the running state based on accelerator operation amount AC, instead of based on vehicle speed VS, it is possible to improve response in switching from the first alignment control to the second alignment control when vehicle 100 starts moving, and as a result, it is possible to prevent occurrence of vehicle behavior not intended by the driver more stably.

Steer-by-wire system 200 illustrated in FIG. 1 separately includes steering operation input apparatus 300, steering apparatus 400, and steering control apparatus 500. However, steering operation input apparatus 300 or steering apparatus 400 may include steering control apparatus 500.

This case in which steering operation input apparatus 300 or steering apparatus 400 incudes steering control apparatus 500 means that the steering operation input apparatus and steering control apparatus 500 constitute a single unit, or steering apparatus 400 and steering control apparatus 500 constitute a single unit.

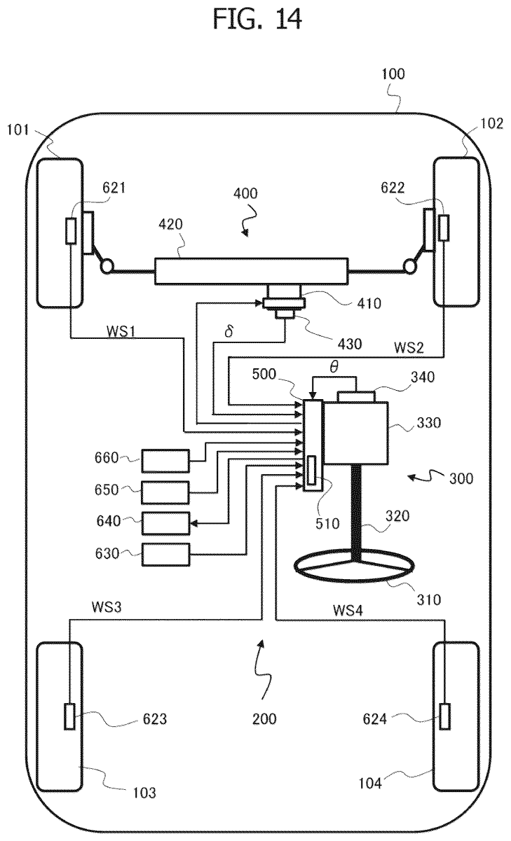

FIG. 14 illustrates steer-by-wire system 200 in which steering operation input apparatus 300 includes steering control apparatus 500.

Steer-by-wire system 200 illustrated in FIG. 14 differs from steer-by-wire system 200 illustrated in FIG. 1 in that steering operation input apparatus 300 includes steering control apparatus 500. Because other constituent elements are the same as those in FIG. 1, detailed description of the individual elements will be omitted.

Steer-by-wire system 200 in FIG. 14 is configured by mounting steering operation input apparatus 300 including steering control apparatus 500, and steering apparatus 400 in vehicle 100.

In addition, steering control apparatus 500 included in steering operation input apparatus 300 outputs a control signal of reaction force motor 330 and a control signal of steering motor 410, based on the transition among the first state (the initial uncontrolled state immediately after steer-by-wire system 200 is started), the second state (the first alignment control), the third state (the normal steering control), and the fourth state (the second alignment control).

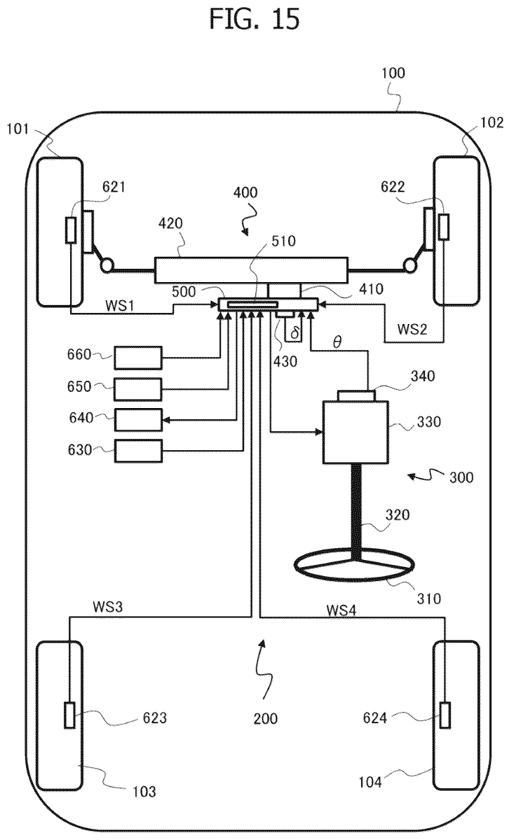

FIG. 15 illustrates steer-by-wire system 200 in which steering apparatus 400 includes steering control apparatus 500.

Steer-by-wire system 200 illustrated in FIG. 15 differs from steer-by-wire system 200 illustrated in FIG. 1 in that steering apparatus 400 includes steering control apparatus 500.

Because other constituent elements are the same as those in FIG. 1, detailed description of the individual elements will be omitted.

Steer-by-wire system 200 in FIG. 15 is configured by mounting steering apparatus 400 including steering control apparatus 500, and steering operation input apparatus 300 in vehicle 100.

Steering control apparatus 500 included in steering apparatus 400 outputs a control signal of reaction force motor 330 and a control signal of steering motor 410, based on the transition among the first state (the initial uncontrolled state immediately after steer-by-wire system 200 is started), the second state (the first alignment control), the third state (the normal steering control), and the fourth state (the second alignment control).

The individual technical concepts described in the above-described example can be appropriately combined and used, as long as there is no conflict.

In addition, although the present invention has thus been described in detail with reference to a preferred example, it will be apparent to those skilled in the art that various kinds of modifications are possible, based on the basic technical concepts and teachings of the present invention.

In the above description, steer-by-wire system 200 is turned ON when the start switch is turned ON. However, steer-by-wire system 200 may be turned ON when it is detected that a passenger enters vehicle 100 or the door lock is released, for example.

In addition, steer-by-wire system 200 may include a backup mechanism that can mechanically couple steering wheel 310 with front road wheels 101 and 102 by using a clutch or the like.

In addition, steering control apparatus 500 may execute both the process of determining whether vehicle 100 is in the stopped state and the running state based on vehicle speed VS and the process of determining whether vehicle 100 is in the stopped state and the running state based accelerator operation amount AC. If the transition to the running state is detected in either one of the determination processes, steering control apparatus 500 may shift the control state from the second state (the first alignment control) to the fourth state (the second alignment control).

In this case, even when accelerator operation amount AC is equal to or less than threshold ACTH, if steering control apparatus 500 detects that vehicle 100 is in the running state based on vehicle speed VS, steering control apparatus 500 shifts the control state from the second state (the first alignment control) to the fourth state (the second alignment control).

Conversely, even when vehicle speed VS is equal to or less than threshold VSTH, if steering control apparatus 500 detects that vehicle 100 is in the running state based on accelerator operation amount AC, steering control apparatus 500 shifts the control state from the second state (the first alignment control) to the fourth state (the second alignment control).

With this configuration, for example, when vehicle 100 on a downward slope in the stopped state releases the brake and starts moving, steering control apparatus 500 can shift the control state to the second alignment control based on increase in vehicle speed VS, and can prevent occurrence of vehicle behavior not intended by the driver.

In addition, when vehicle 100 starts moving with a normal acceleration operation, because accelerator operation amount AC increases before vehicle speed VS increases, steering control apparatus 500 can quickly shift the control state to the fourth state (the second alignment control) in response to the start of moving of vehicle 100.

In addition, steering control apparatus 500 can shift the control state from the second state (the first alignment control) to the fourth state (the second alignment control) based on release of the parking brake.

This is because when the parking brake is released, it can be assumed that vehicle 100 will start moving thereafter, as in the case in which the shift position has changed from parking range P or neutral range N to drive range D or reverse range R.

In addition, when the parking brake is released and when the shift position is shifted to drive range D or reverse range R, steering control apparatus 500 can shift the control state from the second state (the first alignment control) to the fourth state (the second alignment control).

With this configuration, the accuracy in estimating the start of moving of vehicle 100 is improved, and steering control apparatus 500 can shift the control state from the second state (the first alignment control) to the fourth state (the second alignment control) more appropriately.

### REFERENCE SYMBOL LIST

100 Vehicle
101,102 Front road wheel
200 Steer-by-wire system
300 Steering operation input apparatus
310 Steering wheel (steering operation input member)
330 Reaction force motor (first actuator)
400 Steering apparatus
410 Steering motor (second actuator)
500 Steering control apparatus
510 MCU (control unit)

1. A steering control apparatus, which is provided in a vehicle including a steer-by-wire system including a steering operation input apparatus to which a steering operation of a driver is input via a steering operation input member and which has a first actuator that applies torque to the steering operation input member, and including a steering apparatus which has a second actuator that applies steering force to road wheels of the vehicle, and which includes a control unit that outputs a control signal to the first actuator and a control signal to the second actuator,
wherein when the system is turned ON, the control unit acquires a physical quantity about a vehicle speed, a physical quantity about an operation position of the steering operation input member, and a physical quantity about a steering angle of the road wheels,
wherein when a deviation amount of the steering angle with respect to the operation position is equal to or greater than a tolerable amount and when the physical quantity about the vehicle speed is equal to or less than a threshold, the control unit outputs a control signal to the first actuator such that the deviation amount is reduced, and
wherein when the deviation amount of the steering angle with respect to the operation position is equal to or greater than the tolerable amount and when the physical quantity about the vehicle speed is greater than the threshold, the control unit outputs a control signal to the second actuator such that the deviation amount is reduced.

2. The steering control apparatus according to claim 1, wherein the control unit acquires an ON/OFF signal of a start switch of the vehicle, and the control unit determines that the system is turned ON when the start switch of the vehicle is turned ON.

3. The steering control apparatus according to claim 1,
wherein the control unit determines whether the vehicle is in a stopped state or a running state by comparing the physical quantity about the vehicle speed with the threshold,
wherein when the vehicle is in the stopped state, the control unit outputs a control signal to the first actuator such that the deviation amount is reduced, and
wherein when the vehicle is in the running state, the control unit outputs a control signal to the second actuator such that the deviation amount is reduced.

4. The steering control apparatus according to claim 3, wherein when the deviation amount falls below the tolerable amount in the stopped state of the vehicle, the control unit causes the first actuator to apply reaction force torque to the steering operation input member, and causes the second actuator to apply, to the road wheels, steering force based on operation information that is input to the steering operation input apparatus.

5. The steering control apparatus according to claim 3, wherein when outputting a control signal to the second actuator such that the deviation amount is reduced in the running state of the vehicle, the control unit causes the first actuator to apply reaction force torque to the steering operation input member.

6. The steering control apparatus according to claim 5, wherein when the deviation amount falls below the tolerable amount in the running state of the vehicle, the control unit causes the first actuator to apply reaction force torque to the steering operation input member, and causes the second actuator to apply, to the road wheels, steering force based on operation information that is input to the steering operation input apparatus.

7. The steering control apparatus according to claim 3,
wherein when outputting a control signal to the first actuator such that the deviation amount is reduced in the stopped state of the vehicle, the control unit permits the driver's intervention to change the operation position, and
wherein when the deviation amount falls below the tolerable amount, the control unit causes the first actuator to apply reaction force torque to the steering operation input member.

8. The steering control apparatus according to claim 3,
wherein when outputting a control signal to the first actuator such that the deviation amount is reduced in the stopped state of the vehicle, if a driving mode of an automatic transmission of the vehicle is changed from a parking range or a neutral range to a drive range or a reverse range, the control unit switches to a state in which the control unit outputs a control signal to the second actuator such that the deviation amount is reduced.

9. The steering control apparatus according to claim 3,
wherein when outputting a control signal to the second actuator such that the deviation amount is reduced in the running state of the vehicle, the control unit sets a higher operation speed to the second actuator for a larger physical quantity about the vehicle speed.

10. The steering control apparatus according to claim 1,
wherein the control unit activates a warning device installed in the vehicle when outputting a control signal to the first actuator or the second actuator such that the deviation amount is reduced.

11. The steering control apparatus according to claim 1,
wherein the control unit acquires a physical quantity about an accelerator operation amount of the vehicle, as the physical quantity about the vehicle speed,
wherein the control unit outputs a control signal to the first actuator such that the deviation amount is reduced when the physical quantity about the accelerator operation amount is equal to or less than a threshold, and
wherein the control unit outputs a control signal to the second actuator such that the deviation amount is reduced when the physical quantity about the accelerator operation amount is greater than the threshold.

12. The steering control apparatus according to claim 1, wherein if the deviation amount does not fall below the tolerable amount even when the first actuator has operated continuously for a setting time, the control unit stops outputting the control signal to the first actuator.

13. The steering control apparatus according to claim 12, wherein after the control unit stops outputting the control signal to the first actuator, the control unit outputs a control signal to the second actuator such that the deviation amount is reduced.

14. The steering control apparatus according to claim 13, wherein after the control unit stops outputting the control signal to the first actuator, when the control unit outputs a control signal to the second actuator, the control unit causes the first actuator to apply reaction force torque to the steering operation input member.

15. A steering control method, which is executed by a control unit installed in a vehicle including a steer-by-wire system including a steering operation input apparatus to which a steering operation of a driver is input via a steering operation input member and which has a first actuator that applies torque to the steering operation input member, and including a steering apparatus which has a second actuator that applies steering force to road wheels of the vehicle, the steering control method comprising:
acquiring, when the system is turned ON, a physical quantity about a vehicle speed, a physical quantity about an operation position of the steering operation input member, and a physical quantity about a steering angle of the road wheels;
outputting, when a deviation amount of the steering angle with respect to the operation position is equal to or greater than a tolerable amount and when the physical quantity about the vehicle speed is equal to or less than a threshold, a control signal to the first actuator such that the deviation amount is reduced; and
outputting, when the deviation amount of the steering angle with respect to the operation position is equal to or greater than the tolerable amount and when the physical quantity about the vehicle speed is greater than the threshold, a control signal to the second actuator such that the deviation amount is reduced.

16. A steer-by-wire system mounted in a vehicle, the steer-by-wire system comprising:
a steering operation input apparatus to which a steering operation of a driver is input via a steering operation input member and which has a first actuator that applies torque to the steering operation input member;
a steering apparatus which has a second actuator that applies steering force to road wheels of the vehicle; and
a control unit that outputs a control signal to the first actuator and a control signal to the second actuator,
wherein when the system is turned ON, the control unit acquires a physical quantity about a vehicle speed, a physical quantity about an operation position of the steering operation input member, and a physical quantity about a steering angle of the road wheels,
wherein when a deviation amount of the steering angle with respect to the operation position is equal to or greater than a tolerable amount and when the physical quantity about the vehicle speed is equal to or less than a threshold, the control unit outputs a control signal to the first actuator such that the deviation amount is reduced, and
wherein when the deviation amount of the steering angle with respect to the operation position is equal to or greater than the tolerable amount and when the physical quantity about the vehicle speed is greater than the threshold, the control unit outputs a control signal to the second actuator such that the deviation amount is reduced.

17. A steering control apparatus included in a steering apparatus, which has a second actuator that applies steering force to road wheels of a vehicle and which is included in a steer-by-wire system including a steering operation input apparatus to which a steering operation of a driver is input via a steering operation input member and which has a first actuator that applies torque to the steering operation input member, the steering control apparatus comprising:
a control unit that outputs a control signal to the first actuator and a control signal to the second actuator,
wherein when the system is turned ON, the control unit acquires a physical quantity about a vehicle speed, a physical quantity about an operation position of the steering operation input member, and a physical quantity about a steering angle of the road wheels,
wherein when a deviation amount of the steering angle with respect to the operation position is equal to or greater than a tolerable amount and when the physical quantity about the vehicle speed is equal to or less than a threshold, the control unit outputs a control signal to the first actuator such that the deviation amount is reduced, and
wherein when the deviation amount of the steering angle with respect to the operation position is equal to or greater than the tolerable amount and when the physical quantity about the vehicle speed is greater than the threshold, the control unit outputs a control signal to the second actuator such that the deviation amount is reduced.

18. A steering control apparatus included in a steering operation input apparatus, to which a steering operation of a driver is input via a steering operation input member and which has a first actuator that applies torque to the steering operation input member and which is included in a steer-by-wire system including a steering apparatus having a second actuator that applies steering force to road wheels of a vehicle, the steering control apparatus comprising:
a control unit that outputs a control signal to the first actuator and a control signal to the second actuator,
wherein when the system is turned ON, the control unit acquires a physical quantity about a vehicle speed, a physical quantity about an operation position of the steering operation input member, and a physical quantity about a steering angle of the road wheels,
wherein when a deviation amount of the steering angle with respect to the operation position is equal to or greater than a tolerable amount and when the physical quantity about the vehicle speed is equal to or less than a threshold, the control unit outputs a control signal to the first actuator such that the deviation amount is reduced, and
wherein when the deviation amount of the steering angle with respect to the operation position is equal to or greater than the tolerable amount and when the physical quantity about the vehicle speed is greater than the threshold, the control unit outputs a control signal to the second actuator such that the deviation amount is reduced.
